(19) United States
(12) Patent Application Publication
(10) Pub. No.: US 2015/0226169 A1
(43) Pub. Date: Aug. 13, 2015

(54) FUEL PUMP ARRANGEMENTS

(71) Applicant: DELPHI INTENATIONAL OPERATIONS LUXEMBOURG, S.A.R.L, BASCHARAGE (LU)

(72) Inventor: Edward T. Williams, London (GB)

(21) Appl. No.: 14/419,272

(22) PCT Filed: Jul. 29, 2013
(86) PCT No.: PCT/EP2013/065865

§ 371 Date: Feb. 3, 2015

(30) Foreign Application Priority Data
Sep. 4, 2012 (EP) 12182965.9

(51) Int. Cl. F02M 63/02; F02M 59/10

(52) U.S. Cl. CPC F02M 63/0265; F02M 59/102

(57) ABSTRACT

A fuel pump arrangement for a fuel injection system is described. The fuel pump arrangement comprises one or more cam-driven pump units, and the or each pump unit comprises a pumping chamber and a pumping element for pressurising fuel in the pumping chamber. The or each pumping element is driven by a respective cam of the fuel pump arrangement to undergo at least one pumping stroke per revolution of the cam. The fuel pump arrangement is configured such that the fuel volume displaced in a first pumping stroke is greater than the fuel volume displaced in a second pumping stroke. In this way, the efficiency of operation of the fuel pump arrangement can be improved.

### CROSS REFERENCE TO RELATED APPLICATIONS

This application is a national stage application under 35 U.S.C. 371 of PCT Application No. PCT/EP2013/065865 having an international filing date of 29 Jul. 2013, which designated the United States, which PCT application claimed the benefit of European Patent Application No. 12182965.9 filed on 4 Sep. 2012, the entire disclosure of each of which are hereby incorporated herein by reference.

### FIELD OF THE INVENTION

The present invention relates to pump arrangements suitable for pumping fuel. In particular, but not exclusively, the present invention relates to fuel pump arrangements for high-pressure fuel injection systems for internal combustion engines.

### BACKGROUND TO THE INVENTION

In a high-pressure fuel injection system, it is known to use one or more cam-driven pump units to pressurise fuel for delivery to the fuel injectors. Typically, a plurality of pump units is provided so that the pumping effort is distributed over multiple units. Each pump unit comprises a pumping chamber and a pumping plunger that is driven by an associated cam to reciprocate within the pumping chamber. The pumping plunger acts to draw fuel into the pumping chamber from a low-pressure fuel source on a filling or return stroke of the plunger, and to pressurise the fuel in the chamber for delivery to the fuel injectors during a pumping or forward stroke of the plunger.

The components of each pump unit may be integrated with a fuel injector, in an arrangement usually referred to as a “unit injector”. Alternatively, the pump components may be housed separately from the injectors, in so-called “unit pumps”. In either case, the pressurised fuel may be delivered directly from a pump unit to a respective injector. More commonly, the fuel is delivered from the pumps to an accumulator volume or common rail of the fuel injection system to which each of the injectors is connected.

In use, the fuel volume delivered to the engine by the fuel injectors depends on the engine operating conditions, and in particular on the engine load and speed and on the torque demanded in response to throttle application. The injected fuel quantity is controlled by an electronic control unit of the engine in response to these conditions by adjusting both the injection pressure and the injection time. The injection pressure may, for example, range from a few hundred bar pressure at idle, up to 3000 bar or more at maximum load. Accordingly, it is necessary to regulate the fuel pressure in the common rail so that the required volume of fuel at the required pressure is available for injection at any given time during engine operation.

FIG. 1 of the accompanying drawings is a schematic illustration of part of a fuel injection system comprising a known fuel pump arrangement having two unit pumps 10. Each pump comprises a pumping chamber 12 and a pumping plunger 14. The pumping plungers 14 are driven by respective cams 16 of a camshaft 18. The pumping chamber 12 of each pump 10 is in communication with a fuel rail 20 by way of a one-way valve 22 that allows fuel to flow only in the direction towards the fuel rail 20. The fuel rail 20 supplies a plurality of fuel injectors (not shown).

The pumping chamber 12 of each pump 10 is connected to a source 24 of low-pressure fuel by an electronically switchable metering valve 26. The metering valves 26 can be controlled by the electronic control unit (not shown) of the engine to regulate the fuel pressure in the fuel rail 20, as follows.

During a filling stroke, the pumping plunger 14 of a pump 10 moves to increase the volume of the pumping chamber 12. The metering valve 26 associated with the pump 10 is held in an open position during the filling stroke, to allow fuel to be drawn into the pumping chamber 12 from the low-pressure source 24.

The filling stroke ends when the plunger 14 is at the limit of its travel and the volume of the pumping chamber 12 is at a maximum. Then, a pumping stroke of the plunger 14 begins, in which the volume of the pumping chamber 12 decreases as the plunger 14 moves into the chamber 12. During the pumping stroke, the metering valve 26 closes to prevent fuel flowing back from the pumping chamber 12 to the low-pressure source 24.

As the pumping stroke continues, the pressure of fuel in the pumping chamber 12 increases until, when the pressure in the pumping chamber 12 exceeds the pressure in the rail 20, the one-way valve 22 opens to allow fuel to flow under pressure from the pumping chamber 12 to the rail 20.

The pressure of fuel in the fuel rail 20 can be regulated by closing the metering valve 26 over a larger or smaller portion of the pumping stroke of the plunger 14, thereby to control the amount of pressurised fuel that reaches the rail. The fuel pressure in the fuel rail 20 is monitored by a sensor (not shown), which outputs a pressure signal to the electronic control unit. The electronic control unit compares the actual rail pressure to a desired rail pressure, calculated according to the current and predicted demand on the engine. The electronic control unit then calculates the fraction of the pumping stroke for which the metering valve 26 should be closed to increase the rail pressure to the desired rail pressure. The metering valve 26 may be left open at the beginning of the pumping stroke, and then closed at the appropriate time during the pumping stroke, or alternatively the metering valve 26 may be closed at or around the beginning of the pumping stroke, and opened before the end of the pumping stroke. Once the metering valve 26 opens, the remaining pressurised fuel in the pumping chamber 12 spills back to the low-pressure source 24. The fuel pressure in the pumping chamber 12 therefore drops, so that the one-way valve 22 closes to prevent further passage of fuel into the fuel rail 20.

When the maximum possible rail pressure is required, the metering valve 26 can be left closed for substantially the whole of the pumping stroke of the plunger 14. This is the most efficient mode of operation of the pump 10, because the ratio of the volume of high-pressure fuel reaching the rail 20 to the volume of high-pressure fuel returned to the low-pressure source 24 is greatest. Furthermore, the noise, vibration and wear are minimised in this mode of operation, because the valve closes when the rate of rise of the cam 16 is lowest. When lower rail pressures are desired, the efficiency of operation of the pump 10 decreases, because the ratio of the volume of high-pressure fuel reaching the rail 20 to the volume of high-pressure fuel returned to the low-pressure source 24 when the metering valve 26 opens is lower. The noise, vibration and wear associated with operation of the pump 10 also increase.

Another example of a fuel pump arrangement for a fuel injection system is described in the Applicant's granted European Patent No. EP 1921307.

Against this background, it would be desirable to provide a fuel pump arrangement for a fuel injection system which offers improved efficiency, particularly when operating at relatively low injection pressures, but which is also capable of providing fuel for injection at relatively high injection pressures.

### SUMMARY OF THE INVENTION

From a first aspect, the present invention resides in a fuel pump arrangement for a fuel injection system. The fuel pump arrangement comprises one or more cam-driven pump units. The or each pump unit comprises a pumping chamber and a pumping element for pressurising fuel in the pumping chamber. The or each pumping element is driven by a respective cam of the fuel pump arrangement to undergo at least one pumping stroke per revolution of the cam. The fuel pump arrangement is configured such that the fuel volume displaced in a first pumping stroke is greater than the fuel volume displaced in a second pumping stroke.

Because the fuel volume displaced in the first and second pumping strokes differs, the pump arrangement can be operated in a more efficient way than prior art arrangements in which each of the pumps has the same fuel volume displacement per pumping stroke. The present invention allows a choice of either a small or a large volume of fuel to be pumped over a whole pumping stroke, therefore allowing greater control of the rail pressure whilst reducing noise and vibration and maintaining a high pumping efficiency.

In particular, at low injection rates, when the demand for high-pressure fuel is relatively low, fuel can be delivered from the pump arrangement using only the smaller-volume, second pumping stroke. In this way, only the fuel required for delivery is pressurised, and the wastage of pressurised fuel can be avoided. Furthermore, noise and vibration is minimised. At higher injection rates, when the demand for high-pressure fuel is relatively high, fuel can be delivered using the larger-volume, first pumping stroke. In general, fuel can be delivered from part or all of the first pumping stroke and/or part or all of the second pumping stroke to optimise the efficiency of the pump arrangement, and also to optimise the variation in the pressure of fuel output by the pump arrangement.

In one embodiment, the pump arrangement includes a first cam-driven pump unit and a second cam-driven pump unit, and the first pumping stroke is a pumping stroke of the first pump unit, and the second pumping stroke is a pumping stroke of the second pump unit. By controlling the output from the first and second pump units independently, the appropriate combination of the first, larger-volume pumping stroke and the second, smaller-volume pumping stroke can be selected to optimise the efficiency of the pump arrangement.

The pump arrangement may comprise a first cam for driving the pumping element of the first pump unit, and a second cam for driving the pumping element of the second pump unit.

In one embodiment of the invention, the first cam may have a different profile to the second cam, such that the first pumping stroke is longer than the second pumping stroke. In other words, the cam lift of the first cam may be larger than the cam lift of the second cam. In this way, the volume displaced by the first pumping stroke, which occurs in the first pump, is larger than the volume displaced by the second pumping stroke, which occurs in the second pump. In this embodiment, the pumping element of the first pump unit preferably has the same cross-sectional area as the pumping element of the second pump unit.

In another embodiment having first and second pump units, the pumping element of the first pump unit is larger in cross-sectional area than the pumping element of the second pump unit. In this way, movement of the respective pumping elements of the first and second pump units through the same distance results in a larger displacement of fuel in the first pump unit than in the second pump unit. In this embodiment, when a first cam for driving the pumping element of the first pump unit and a second cam for driving the pumping element of second pump unit are provided, the first and second cams may have the same profile, such that the pumping elements have the same stroke length in each pump unit.

In a further embodiment, in which one or more pump units are provided, the cam or at least one of the cams has an asymmetrical cam profile to drive the pumping element of a respective pump unit in the first and second pumping strokes during one revolution of the cam. For example, the asymmetrical cam profile may include a first lobe for driving the first pumping stroke of the pumping element, and a second lobe for driving the second pumping stroke of the pumping element. The first lobe preferably has a higher cam lift than the second lobe, such that the first pumping stroke is longer than the second pumping stroke. In this way, the or each pump unit is capable of supplying either a relatively large volume of pressurised fuel or a relatively small volume of pressurised fuel with maximum efficiency, by pressurising and outputting fuel during the first pumping stroke or the second pumping stroke respectively.

Preferably, the fuel pump arrangement comprises one or more metering valves for switchably connecting the pumping chamber of the or each pump unit to a source of low-pressure fuel. The fuel pump arrangement may further comprise a controller for switching the or each metering valve between an open position, in which the respective pumping chamber is in fluid communication with the source of low-pressure fuel, and a closed position in which the respective pumping chamber is isolated from the source of low-pressure fuel to cause pressurisation of the fuel in the respective pumping chamber and to output the pressurised fuel from the pumping arrangement. The controller may be arranged to calculate a fuel delivery demand, and to switch the or each metering valve such that the pumping arrangement outputs fuel to satisfy the fuel delivery demand.

The fuel pump arrangement may further comprise one or more one-way valves for connecting the pumping chamber of the or each pump unit to a common rail of the fuel injection system.

In a second aspect, the invention resides in a method for delivering fuel to a common rail in a fuel injection system comprising a fuel pump arrangement according to the first aspect of the invention. The method comprises calculating a fuel delivery demand and delivering fuel from the fuel pump arrangement to the common rail during the first pumping stroke and/or the second pumping stroke to satisfy the fuel delivery demand.

The method may comprise delivering fuel from the fuel pump arrangement to the common rail during only a part of the first pumping stroke and/or only a part of the second pumping stroke to satisfy the fuel delivery demand. Similarly, the method may comprise delivering fuel from the fuel pump arrangement to the common rail during only the first pumping stroke or only the second pumping stroke to satisfy the fuel delivery demand.

One embodiment of the invention comprises a fuel pump arrangement for a common rail fuel injection system, comprising first and second cam-driven pump units each pump unit comprising a pumping chamber and a pumping element for pressurising fuel in the pumping chamber, and first and second cams for driving the respective pumping plungers of the first and second pump units in respective pumping strokes. The pumping stroke of the first pump unit displaces a greater volume of fuel than the pumping stroke of the second pump unit.

Another embodiment of the invention comprises a fuel pump arrangement for a common rail fuel injection system, comprising a cam-driven pump unit comprising a pumping chamber and a pumping plunger for pressurising fuel in the pumping chamber, and a cam for driving the pumping plunger of the pump unit. The cam has an asymmetrical cam profile to drive the pumping plunger in first and second pumping strokes during each revolution of the cam, and the first pumping stroke displaces a greater volume of fuel than the second pumping stroke.

Preferred and/or optional features of each aspect and embodiment of the invention may be used, alone or in appropriate combination, in the other aspects and embodiments of the invention also.

### BRIEF DESCRIPTION OF THE DRAWINGS

FIG. 1, which has already been referred to above, is a schematic illustration of part of a conventional fuel injection system comprising a known fuel pump arrangement.

Embodiments of the present invention will now be described, by way of example only, with reference to the accompanying drawings, in which like reference numerals are used for like features, and in which:

FIG. 2 is a schematic illustration of part of a fuel injection system comprising a fuel pump arrangement according to a first embodiment of the present invention;

FIGS. 3(a) and 3(b) are schematic graphs showing the variation of fuel rail pressure with time for two modes of operation of the fuel injection system of FIG. 2, respectively, and FIG. 3(c) is a schematic graph showing the variation of fuel rail pressure with time for a conventional fuel injection system such as that shown in FIG. 1;

FIGS. 4(a) to 4(c) are schematic graphs showing the variation of fuel rail pressure with time corresponding to FIGS. 3(a) to 3(c), but at a higher fuel injection rate;

FIG. 5 is a schematic illustration of part of a fuel injection system comprising a fuel pump arrangement according to a second embodiment of the present invention;

FIG. 6 is a schematic illustration of part of a fuel injection system comprising a fuel pump arrangement according to a third embodiment of the present invention; and

FIG. 7 is a schematic illustration of a cam lobe of the fuel pump arrangement of FIG. 6.

### DETAILED DESCRIPTION OF EMBODIMENTS OF THE INVENTION

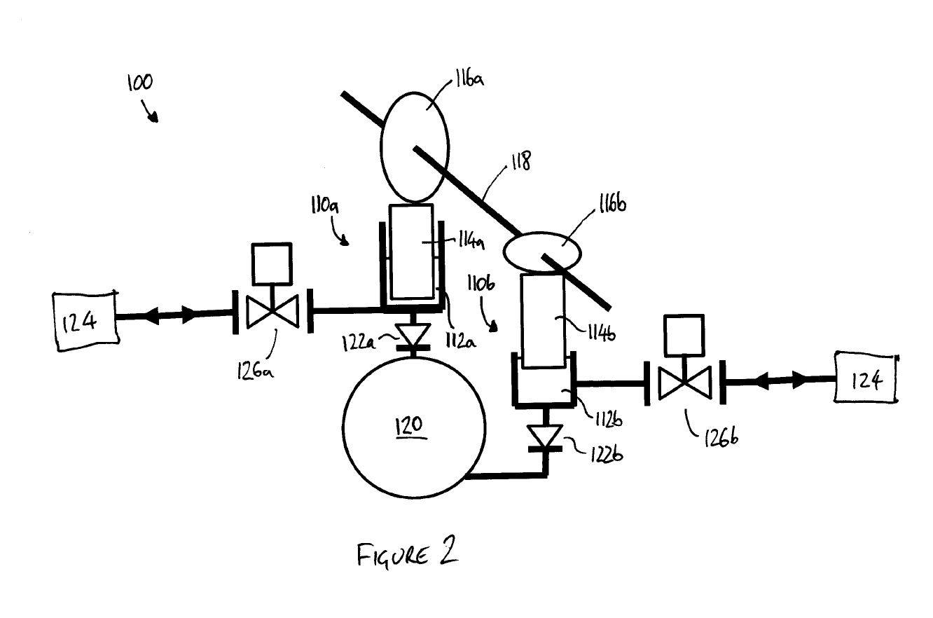

FIG. 2 shows part of a fuel injection system 100 having a fuel pump arrangement according to a first embodiment of the present invention. The fuel pump arrangement includes a plurality of fuel pumps of the unit pump type. In the illustrated embodiment, first and second fuel pump units 110a, 110b are provided.

Each fuel pump unit 110a, 110b, referred to hereafter as a fuel pump, comprises a pumping chamber 112a, 112b and a pumping element or plunger 114a, 114b arranged for reciprocal movement in a plunger bore (not shown) to increase and decrease the volume of the respective pumping chamber 112a, 112b. The pumping plungers 114a, 114b are driven by respective first and second cams 116a, 116b, mounted on a common camshaft 118.

The first cam 116a and the second cam 116b have different cam profiles. Specifically, the first cam 116a has a larger lift than the second cam 116b, the lift of each cam 116a, 116b being the difference between the smallest radius of the cam profile to the largest radius of the cam profile. Because of the difference in lift between the cams 116a, 116b, the first cam 116a drives the pumping plunger 114a of the first pump 110a in a longer stroke compared to the stroke length of the pumping plunger 114b of the second pump 110b, driven by the second cam 116b.

The pumping chamber 112a, 112b of each pump 110a, 110b is connected to a fuel rail 120 by way of a respective one-way valve 122a, 122b that allows fuel to flow only in the direction towards the fuel rail 120. The fuel rail 120 supplies a plurality of fuel injectors (not shown), as will be familiar to those skilled in the art.

The pumping chamber 112a, 112b of each pump 110a, 110b is also connected to a source 124 of low-pressure fuel by a respective electronically switchable metering valve 126a, 126b. The metering valves 126a, 126b can be controlled independently by an electronic control unit (not shown) of the engine to regulate the fuel pressure in the fuel rail 120, as will be described below.

As the camshaft 118 rotates, the cams 116a, 116b drive the respective pumping plungers 114a, 114b of the pumps 110a, 110b in reciprocating linear movement to increase and decrease the volume of the associated pumping chambers 112a, 112b in a cyclical manner.

Taking the first pump 110a as an example, during a respective filling or return stroke of the pumping plunger 114a of the first pump 110a, the pumping plunger 114a moves to increase the volume of the pumping chamber 112a. The metering valve 126a associated with the first pump 110a is held in an open position during the filling stroke, to allow fuel to be drawn into the pumping chamber 112a from the low-pressure source 124.

The filling stroke of the first pump 110a ends when the plunger 114a is at the limit of its return travel and the volume of the respective pumping chamber 112a is at a maximum. Then, on continued rotation of the cam 116a, a pumping stroke of the plunger 114a begins, in which the volume of the pumping chamber 112a decreases as the plunger 114a moves into the chamber 112a. The pumping stroke ends when the plunger 114a reaches the limit of its forward travel, at which point the volume of the pumping chamber 112a is a maximum, and the next filling stroke begins. The stroke length of the plunger 114a (i.e. the distance between the limits of its forward and reverse travel), and therefore the volume of fuel in the pumping chamber 112a displaced during the pumping stroke of the plunger 114a, is determined by the lift of the cam 116a.

The second pump 110b operates in the same way. However, because the second cam 116b, which drives the plunger 114b of the second pump 110b, has a profile with a smaller lift than the first cam 116a, the volume of fuel in the pumping chamber 112b displaced during a pumping stroke in the second pump 110b is less than the volume of fuel displaced during a pumping stroke in the first pump 110a.

The first and second cams 116a, 116b are arranged on the camshaft 118 at a 90° offset to one another. In this way, while the plunger 114a of the first pump 110a is moving in a pumping stroke, the plunger 114b of the second pump 110b is moving in a filling stroke, and vice versa. In the illustrated embodiment, the cams 116a, 116b are double-lobed, so that two pumping cycles (i.e. a filling stroke followed by a pumping stroke) take place over each rotation of the camshaft 118.

The metering valves 126a, 126b are used to control the fuel pressure in the fuel rail 120. Advantageously, by controlling the metering valves 126a, 126b independently, the amount of fuel reaching the rail 120 from the first pump 110a and the second pump 110b respectively can be independently regulated to maximise the efficiency of operation of the fuel injection system.

For example, when it is desired to pump fuel into the fuel rail 120 using the first pump 110a, the electronic control unit closes the first metering valve 126a during the pumping stroke, to prevent fuel flowing back from the pumping chamber 112a of the first pump 110a to the low-pressure source 124. As the pumping stroke continues, the pressure of fuel in the pumping chamber 112a increases until, at a pre-determined pressure, the one-way valve 122a that connects the first pump 110a to the fuel rail 120 opens to allow fuel to flow under pressure from the pumping chamber 112a to the rail 120. At the end of the pumping stroke, the first metering valve 126a is opened to allow the pumping chamber 112a to fill during the next filling stroke.

If it is desired to deliver the maximum volume of pressurised fuel from the first pump 110a to the rail 120, the first metering valve 126a can be held in its closed state for substantially all of the pumping stroke. In this case, substantially the whole of the volume of fuel displaced during the pumping stroke is pressurised and delivered to the rail 120.

Alternatively, if it is desired to deliver less than the maximum volume of pressurised fuel from the first pump 110a to the rail 120, then the first metering valve 126a can be held in its closed state for only a part of the pumping stroke. For example, the first metering valve 126a can be held open at the beginning of the pumping stroke, and closed at an appropriate point during the pumping stroke to deliver the appropriate volume of pressurised fuel to the rail 120.

Fuel passes to the fuel rail 120 through the one-way valve 122a only whilst the first metering valve 126a is closed. If the first metering valve 126a is opened during the pumping stroke, the pressure in the pumping chamber 112a drops and the one-way valve 122a closes, stopping the flow of fuel into the rail 120 from the first pump 110a. The remaining fuel volume displaced by the plunger 114a during the remainder of the pumping stroke passes back to the low-pressure source 124 without pressurisation.

The flow of pressurised fuel from the second pump 110b to the rail 120, through the associated one-way valve 122b, can be controlled in a similar way by opening and closing the second metering valve 126b.

The electronic control unit is arranged to calculate the appropriate opening and closing times for the first and second metering valves 126a, 126b by determining the difference between the actual fuel pressure in the fuel rail 120 and the fuel pressure that will be needed to satisfy the fuel delivery demand (i.e. the pressure required to supply the appropriate volume of fuel, at the appropriate pressure, to the injectors to satisfy the current and predicted torque demand on the engine). The actual fuel pressure in the fuel rail 120 is monitored by a sensor (not shown). As will be familiar to a person skilled in the art, the required rail pressure that will be needed to satisfy the torque demand can be determined by the electronic control unit from suitable sensor inputs, for example from a throttle position sensor, a crankshaft position sensor, temperature sensors, air flow sensors and so on.

The fuel pressure in the rail 120 as a function of time follows a generally sawtooth curve. The fuel pressure decays over time as fuel is injected by the injectors, and increases sharply when fuel is delivered to the rail by each of the fuel pumps 110a, 110b. The electronic control unit therefore calculates a target minimum rail pressure, which reflects the current minimum injection pressure required to satisfy the fuel demand, and a target peak rail pressure, which is sufficiently above the target rail pressure to allow for the pressure decay between pumping events.

The electronic control unit compares the measured rail pressure to the target minimum and target peak rail pressures, and sends output signals to the first and second metering valves 126a, 126b accordingly to keep the actual rail pressure between the target peak rail pressure and the target minimum rail pressure.

As the actual rail pressure approaches the target minimum rail pressure, the electronic control unit closes one or both of the metering valves 126a, 126b during the respective pumping strokes of the plungers 114a, 114b to feed high-pressure fuel from the first pump 110a and/or the second pump 110b to the fuel rail 120. Once sufficient high-pressure fuel has been delivered to the rail 120 for the actual rail pressure to reach the target peak rail pressure, the electronic control unit opens the required metering valves 126a, 126b to spill the remaining fuel in the pumping chambers 122a, 122b back to the low-pressure source 124.

In practice, rather than continually monitoring the rail pressure whilst the pumping stroke takes place, the electronic control unit calculates in advance of each pumping stroke the required closing and opening times for the metering valves 126a, 126b to ensure that the desired fraction of the pumping stroke of each pump 110a, 110b is used to pump fuel to the rail 120.

Advantageously, this strategy allows each metering valve 126a, 126b to be closed when appropriate during a respective pumping stroke and opened at the end of the pumping stroke, so as to minimise the amount of pressurised fuel that is spilt to the low-pressure source 124 when the metering valve 126a, 126b opens. It will be appreciated, though, that even when the metering valves 126a, 126b remain closed until the end of a pumping stroke, some pressurised fuel will be lost to the low pressure source 124 due to the dead volume of the pumps 110a, 110b. As will be understood by a person skilled in the art, the dead volume corresponds to the volume of fuel that remains in the pumping chambers 122a, 122b at the end of each pumping stroke.

Because each pump 110a, 110b delivers a different volume of pressurised fuel with each pumping stroke, several different modes of operation can be adopted to optimise the efficiency and performance of the pump arrangement.

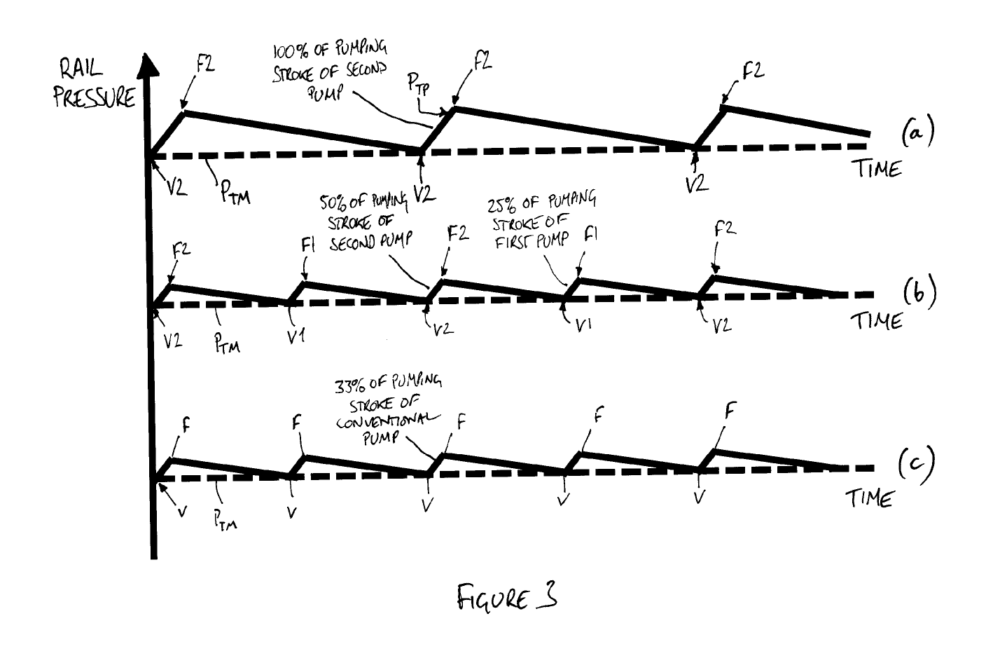

FIG. 3(a) is a schematic plot of rail pressure against time for the fuel injection system of FIG. 2 operating at a relatively low injection rate, with the pump arrangement operating in a first mode, which offers high efficiency operation. In this example, the target minimum rail pressure (P_{TM}) is relatively low, and can be maintained by pumping with the second pump 110b alone.

Therefore, at the start of a pumping stroke of the second pump 110b, the second metering valve 126b is closed. This point is labelled V2 on FIG. 3(a). The second metering valve 126b remains closed for the whole of the pumping stroke of the second pump 110b, causing the rail pressure to increase to the target peak rail pressure (P_{TP}). The end of the pumping stroke is labelled F2 on FIG. 3(a). The second metering valve 126b then opens, allowing the pumping chamber 112b of the second pump 110b to re-fill during the filling stroke of the plunger 114b. Once the rail pressure decays back to the target minimum rail pressure P_{TM}, the second metering valve 126b is closed at the start of the next pumping stroke (V2) to raise the rail pressure once more.

In this first mode of operation, therefore, substantially all of the pumping effort of the second pump 110b goes into raising the fuel pressure in the rail 120. Only a minimal amount of pressurised fuel is spilt from the pumping chamber 112b to the low-pressure source 124, due to the dead volume in the pump 110a. The first metering valve 126a remains open throughout, so that no fuel is pumped from the first pump 110a to the rail. Because the pumping chamber 112a of the first pump 110a remains open to the low pressure source 124, no fuel is pressurised in the first pump 110a and minimal energy is wasted. Accordingly, this mode of operation achieves maximum efficiency at relatively low injection rates. Also, because closure of the metering valves 126a, 126b during a pumping stroke is avoided, noise, vibration and wear are minimised in this mode of operation.

It will be appreciated from FIG. 3(a) that, in the first mode of operation, the variation in fuel pressure in the rail 120 (i.e. the difference between the target minimum pressure P_{TM} and the target peak pressure P_{TP}) is relatively large. By splitting the pumping load between the first pump 110a and the second pump 110b, however, a reduced variation in rail pressure can be achieved for the same injection rate. A second mode of operation, which operates in this fashion, will be described with reference to FIG. 3(b).

In this example, the lift of the first cam 116a is twice the lift of the second cam 116b. Therefore the volume of fuel displaced in a full pumping stroke of the first pump 110a is twice the volume of fuel displaced in a full pumping stroke of the second pump 110b. In the second mode of operation, the target minimum rail pressure P_{TM} is maintained by closing the first metering valve 126a for 25% of the pumping stroke of the first pump 110a, and by closing the second metering valve 126b for 50% of the pumping stroke of the second pump 110b. Because of the difference in fuel volume displaced by the respective pumping strokes, these ratios mean that each stroke results in the rail pressure rising to the same target peak rail pressure P_{TP}. The pumping stroke of the second pump 110b occurs during the filling stroke of the first pump 110a, and vice versa, due to the offset of the first and second cams 116a, 116b. The closing times of the first and second metering valves 126a, 126b are indicated by V1 and V2 respectively in FIG. 3(b), and the opening times are indicated by F1 and F2.

As can be seen from FIG. 3(b), in this second mode of operation the rail pressure remains closer to the target minimum pressure P_{TM} compared to the first mode of operation shown in FIG. 3(a). Thus, in the second mode of operation, although the efficiency of operation is somewhat lower than the first mode of operation, the consistency of injection pressure can be improved.

Even though, in the second mode of operation, the ratio of the fuel delivered to the rail 120 to the fuel spilt to the low pressure source 124 is lower than in the first mode of operation, an improvement in efficiency is still obtained compared to an arrangement according to the prior art, in which all of the pumps displace the same volume of fuel per pumping stroke.

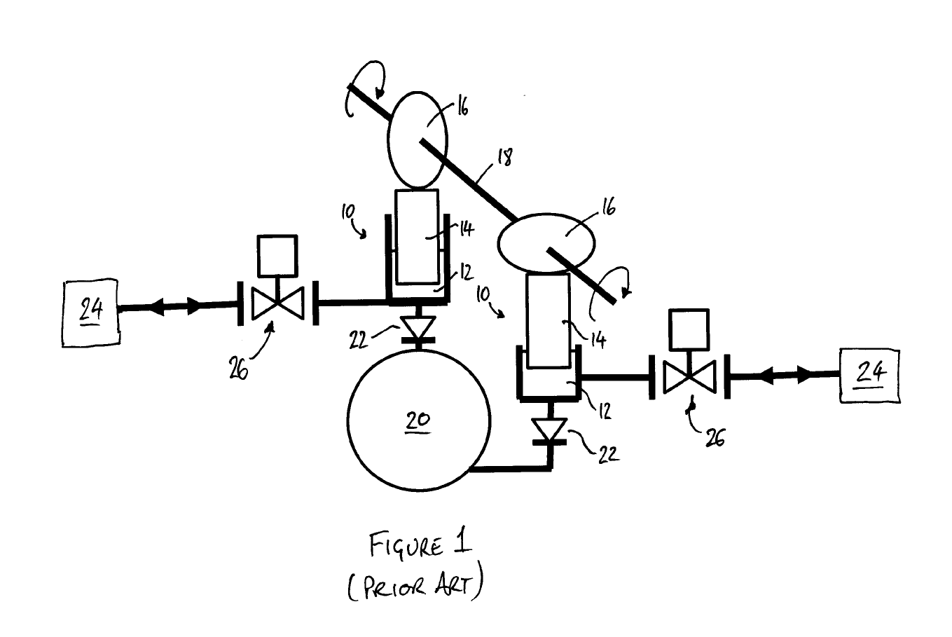

For comparison, FIG. 3(c) shows a schematic pressure-time plot for the prior art arrangement shown in FIG. 1, in which the pumps 10 are driven by cams 16 with the same profile for each pump 10. The cams 16 are sized such that, in the FIG. 1 arrangement, each pump 10 displaces the same volume of fuel during a pumping stroke, which is equal to 75% of the volume displaced by the first pump 110a per pumping stroke in FIG. 2, or equivalently to 150% of the volume displaced by the second pump 110b per pumping stroke. In this way, the total displacement of both pumps 10 together in the conventional arrangement of FIG. 1 is the same as the total displacement of both pumps 110a, 110b together in the arrangement according to the invention of FIG. 2.

To achieve the same variation in rail pressure as achieved by the arrangement of FIG. 2 operating in the second mode, as shown in FIG. 3(b), the arrangement of FIG. 1 with conventionally-sized cams requires that the metering valves are open for one-third of the pumping stroke of each pump, as shown in FIG. 3(c). The closing times of the valves are labelled V, and the opening times are labelled F in FIG. 3(c).

Compared to the second mode illustrated in FIG. 3(b), operation of the conventional arrangement as shown in FIG. 3(c) is less efficient.

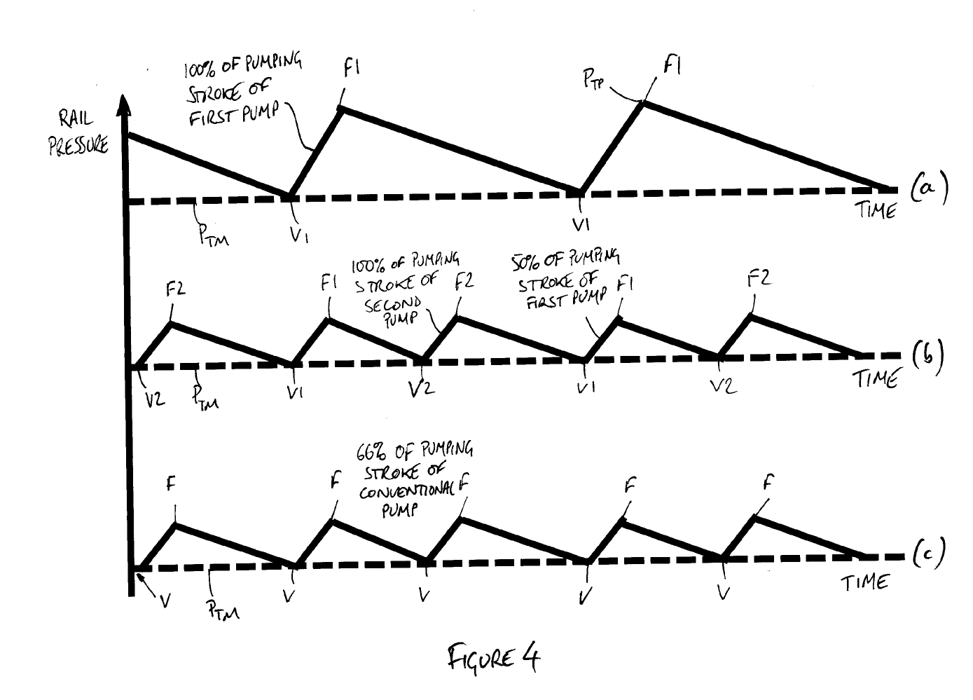

When the injection rate is higher, a greater volume of fuel is needed to satisfy the fuel demand. FIGS. 4(a) to 4(c) show the variation in rail pressure with time for the equivalent situations as FIGS. 3(a) to 3(c), but at a higher injection rate.

In FIG. 4(a), the arrangement of FIG. 2 is operated in a third mode of operation, in which the rail pressure is maintained by pumping using the first pump 110a alone, using 100% of the capacity of the first pump 110a. Therefore, the first metering valve 126a is closed at the start of a pumping stroke of the first pump 110a, indicated by V1 in FIG. 4(a), and remains closed until the end of the pumping stroke, indicated by F1. The second metering valve 126b remains open throughout, so that no fuel is pumped into the rail 120 by the second pump 110b.

This third mode of operation maximises the efficiency of the arrangement, since all of the pumping effort of the first pump 110a is used to increase the pressure of fuel in the rail 120, whilst no pumping effort is expended in pressurising fuel in the second pump 110b.

The variation in rail pressure can be reduced by sharing the pumping load between the first and second pumps 110a, 110b. Therefore, in a fourth mode of operation, shown in FIG. 4(b), the first metering valve 126a is closed for half of the pumping stroke of the first pump 110a, and the second metering valve 126b is closed for the entire pumping stroke of the second pump 110b. In this way, the same demand for fuel as in FIG. 4(a) can be satisfied, but with lower variation in the rail pressure.

Although the fourth mode of operation is less efficient than the third mode of operation, satisfying the equivalent fuel demand using a conventional arrangement in which each pump has the same displacement per pumping stroke, such as is shown in FIG. 1, is less efficient still. The pressure-time curve for the arrangement of FIG. 1 is shown in FIG. 4(c). To obtain the same target minimum rail pressure P_{TM} with the same variability in pressure as the fourth mode of the arrangement of FIG. 2, the metering valves 22 of the FIG. 1 arrangement must be closed for two-thirds of the pumping stroke of each pump 10. This results in a lower efficiency than the fourth mode of operation of the arrangement of FIG. 2.

It will be appreciated by a person skilled in the art that the mode of operation of the pump arrangement according to the invention can be optimised for a particular application and for particular engine operating conditions. For example, for any given injection rate, the pump arrangement could be controlled by the electronic control unit to deliver fuel to the rail 120 with maximum efficiency or with minimum rail pressure variation, or with a suitable compromise between efficiency and pressure variation to optimise the operation of the fuel injection system as a whole.

In variants of the first embodiment of the invention, further pumps may be provided. For example, a set of two or more pumps driven by respective cams of the same profile as the first cam 116a, and a set of two or more further pumps driven by respective cams of the same profile as the second cam 116b may be provided. In this way, a greater demand for fuel quantity and/or pressure can be satisfied by the pump arrangement. In another variant, one or more additional pumps driven by cams with geometries intermediate between the first cam 116a and the second cam 116b may be provided. Such an arrangement allows a further improvement in efficiency compared to the arrangements known in the prior art.

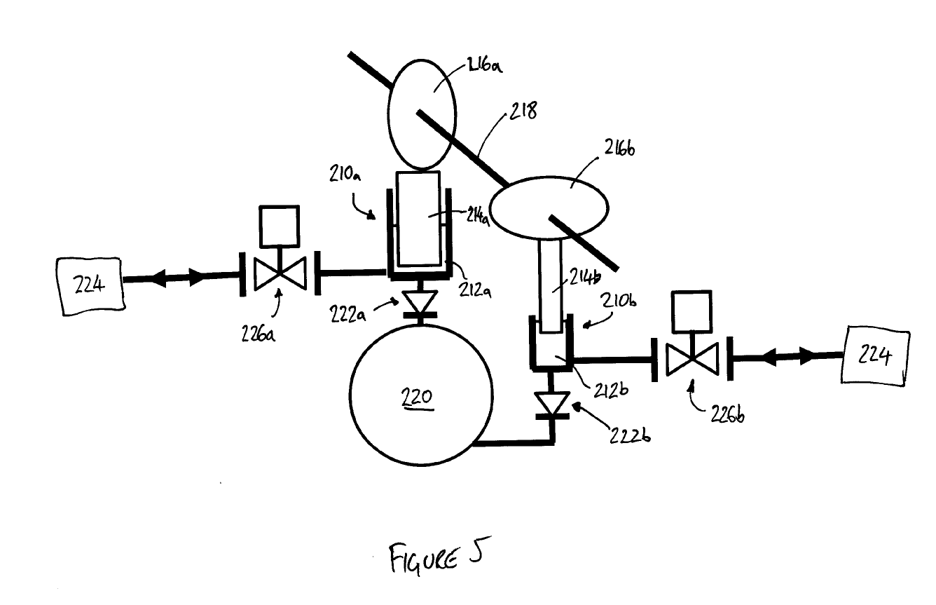

A fuel injection system having a fuel pump arrangement according to a second embodiment of the present invention is shown in FIG. 5. As in the first embodiment, in this second embodiment, first and second fuel pumps 210a, 210b are provided. Each fuel pump 210a, 210b comprises a pumping chamber 212a, 212b and a pumping plunger 214a, 214b arranged for reciprocal movement in a plunger bore (not shown). The pumping plungers 214a, 214b are driven by respective first and second cams 216a, 216b, mounted on a common camshaft 218.

The second embodiment of the invention differs from the first embodiment in that, in the second embodiment, the first and second cams 216a, 216b have identical cam profiles. Instead, to achieve a difference in the volume of fuel displaced per pumping stroke by the first and second pumps 210a, 210b, the pumping plunger 214a and the associated pumping chamber 212a of the first pump 210a have larger diameters than the pumping plunger 214b and the associated pumping chamber 212b of the second pump 210b.

In this way, although the stroke of each pumping plunger 214a, 214b is the same, the volume displaced by the plunger 214a of the first pump 210a during a pumping stroke is greater than the volume displaced by the plunger 214b of the second pump 210b. Specifically, the cross-sectional area of the plunger 214a of the first pump 210a is twice the cross-sectional area of the plunger 214b of the second pump 210b, so that the first pump 210a displaces twice as much fuel per pumping stroke as the second pump 210b.

As in the first embodiment of the invention, in the second embodiment the pumping chamber 212a, 212b of each pump 210a, 210b is connected to a fuel rail 220 by way of a respective one-way valve 222a, 222b, and to a source 224 of low-pressure fuel by a respective electronically switchable metering valve 226a, 226b.

Operation of the pump arrangement of the second embodiment of the invention is the same as in the first embodiment of the invention as described above.

The pump arrangement of the second embodiment of the invention provides a useful alternative to the arrangement of the first embodiment. For instance, the use of pumps 210a, 210b with different plunger diameters driven by identical cams 216a, 216b can be advantageous when it is desirable to provide a balanced pump camshaft. Furthermore, in a variant of the second embodiment of the invention, the first and second pumps can be driven from the same cam, since the pumps themselves are arranged to output different volumes of fuel for the same stroke length.

In further variants of the second embodiment of the invention, further pumps may be provided. For example, a set of two or more pumps having relatively large plungers, and a set of two or more further pumps having relatively small plungers may be provided. In this way, a greater demand for fuel quantity and/or pressure can be satisfied by the pump arrangement. In another variant, one or more additional pumps with plunger diameters intermediate between the plunger diameter of the first pump 210a and the plunger diameter of the second pump 210b may be provided. Such an arrangement allows a further improvement in efficiency compared to the arrangements known in the prior art.

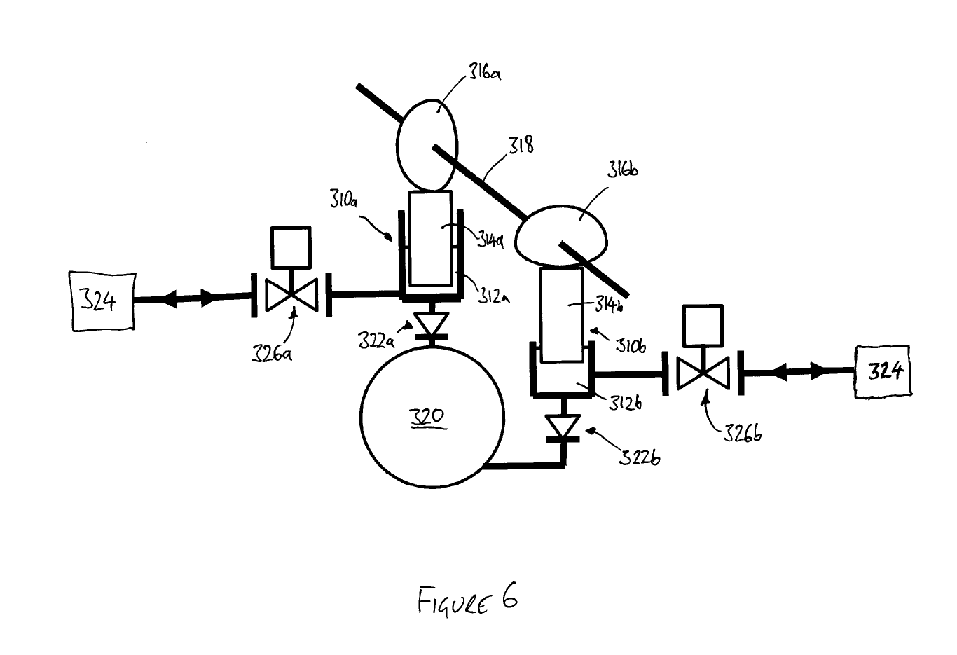

FIG. 6 shows part of a fuel injection system having a pump arrangement according to a third embodiment of the invention.

As in the first and second embodiments, in this third embodiment, first and second fuel pumps 310a, 310b are provided. Each fuel pump 310a, 310b comprises a pumping chamber 312a, 312b and a pumping plunger 314a, 314b arranged for reciprocal movement in a plunger bore (not shown). The pumping plungers 314a, 314b are driven by respective first and second cams 316a, 316b, mounted on a common camshaft 318.

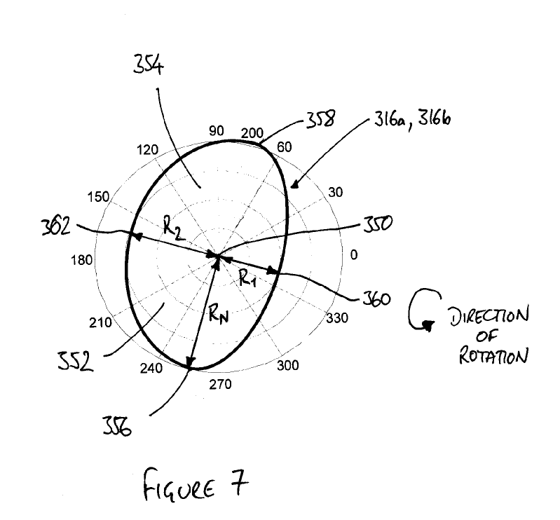

In this third embodiment, the first and second cams 316a, 316b have identical, asymmetrical cam profiles, as shown in more detail in FIG. 7. Each cam 316a, 316b rotates about an axis 350, which is mounted coaxially on the camshaft 318. Two lobes 352, 354, defining first and second noses 356, 358 respectively, are diametrically opposed across the axis 350. Each nose 352, 354 lies at a radius R_{N} from the axis 350.

The points of minimum radius 360, 362 of the cam 316a, 316b, between the lobes 352, 354, are located at different radii on each side of the cam 316a, 316b. With the cam 316a, 316b rotating in an anticlockwise direction, the point of minimum radius 360 that precedes the first lobe 352 lies at a radius R₁ from the axis 350, and the point of minimum radius 362 that precedes the second lobe 354 lies at a radius R₂ from the axis 350. The radius R₂ is twice the radius R₁.

Accordingly, as the camshaft 318 rotates, each cam 316a, 316b drives the respective pumping plunger 314a, 314b in two pumping cycles per revolution. The pumping stroke of the first pumping cycle is driven by the first lobe 352, so that this first pumping stroke has a stroke length given by R_{N}−R₁. The pumping stroke of the second pumping cycle is driven by the second lobe 354, so that this second pumping stroke has a stroke length given by R_{N}−R₂.

The first pumping stroke is therefore twice as long as the second pumping stroke. Accordingly, the fuel volume displaced during the first pumping cycle of each pump 310a, 310b is twice that displaced during the second pumping cycle of each pump 310a, 310b.

As in the first and second embodiments of the invention, in the third embodiment the pumping chamber 312a, 312b of each pump 310a, 310b is connected to a fuel rail 320 by way of a respective one-way valve 322a, 322b, and to a source 324 of low-pressure fuel by a respective electronically switchable metering valve 326a, 326b.

Operation of the arrangement according to the third embodiment of the invention is similar to operation of the arrangements of the first and second embodiments of the invention. In this case, both pumps 310a, 310b are capable of providing either large or small volumes of fuel per pumping stroke, corresponding to the first and second pumping strokes that occur in each pump 310a, 310b during each revolution of the camshaft 318. For each revolution of the camshaft 318, the electronic control unit can select independently the proportion of the first (longer) pumping stroke and the second (shorter) pumping stroke for which the respective metering valve 326a, 326b should remain closed.

The third embodiment of the invention provides a useful alternative to the first and second embodiments. Advantageously, because the pumps 310a, 310b are identical and the asymmetrical cams 316a, 316b are also identical, this embodiment of the invention provides a relatively simple arrangement with a lower unique component count than the previously-described embodiments.

It will be appreciated that, because each pump in the third embodiment of the invention can deliver both the small-displacement and large-displacement pumping strokes, one pump alone could be sufficient to obtain the benefit of the invention. In one variant of the third embodiment, therefore, only one pump is provided. In other variants, three or more pumps could be provided to satisfy greater volume and/or pressure demands. It will also be appreciated that two or more pumps could be driven from the same asymmetrical cam. A cam profile with three or more lobes, to provide multiple pumping strokes with different stroke lengths, could also be used.

In another variant of the third embodiment of the invention, the cams 316a, 316b have different asymmetric profiles, such that each of the pumps 310a, 310b supplies a different volume of fuel on its respective first and second pumping strokes. Such an arrangement can offer further refinements in optimising the efficiency of the pumping arrangement.

It will be appreciated by a person skilled in the art that the above-described embodiments and variants of the invention are examples only, and that other pumping arrangements not explicitly described above but capable of delivering a fuel volume in a first pumping stroke that is greater than a fuel volume delivered in a second pumping stroke could also be contemplated.

It would, for example, be possible to combine two or more of the features of the above-described embodiments. For instance, two or more pumps with pumping plungers having different cross-sectional areas could also be driven by cams with asymmetrical cam profiles.

In the above-described embodiments, the volume of fuel displaced in the first pumping stroke is twice the volume of fuel displaced in the second pumping stroke. However, it will be appreciated that the relative volumes of fuel displaced in the first and second pumping strokes can be selected as appropriate for a given application. Further embodiments of the invention can be contemplated in which three or more pumping strokes, each displacing a different volume of fuel, are available. In this way, a greater number of maximum-efficiency modes of operation could be provided.

Further modifications and variations are also possible without departing from the scope of the invention as defined in the appended claims.

1. A fuel pump arrangement for a fuel injection system, the fuel pump arrangement comprising a cam-driven pump unit;
wherein the pump unit comprises a pumping chamber and a pumping element for pressurising fuel in the pumping chamber;
the pumping element being driven by a cam of the fuel pump arrangement to undergo a first pumping stroke and a second pumping stroke per revolution of the cam;
wherein the fuel pump arrangement is configured such that the fuel volume displaced in the first pumping stroke is greater than the fuel volume displaced in the second pumping stroke; and wherein the cam has an asymmetrical cam profile to drive the pumping element of its respective pump unit in the first and second pumping strokes during one revolution of the cam.

2.-7. (canceled)

8. A fuel pump arrangement according to claim 1, wherein the asymmetrical cam profile includes a first lobe for driving the first pumping stroke of the pumping element, and a second lobe for driving the second pumping stroke of the pumping element, and wherein the first lobe has a higher cam lift than the second lobe such that the first pumping stroke is longer than the second pumping stroke.

9. A fuel pump arrangement according to claim 1, further comprising one or more metering valves for switchably connecting the pumping chamber of the or each pump unit to a source of low-pressure fuel.

10. A fuel pump arrangement according to claim 9, further comprising a controller for switching the or each metering valve between:
(i) an open position in which the respective pumping chamber is in fluid communication with the source of low-pressure fuel; and
(ii) a closed position in which the respective pumping chamber is isolated from the source of low-pressure fuel to cause pressurisation of the fuel in the respective pumping chamber and to output the pressurised fuel from the pumping arrangement.

11. A fuel pump arrangement according to claim 10, wherein the controller is arranged to calculate a fuel delivery demand, and to switch the or each metering valve such that the pumping arrangement outputs fuel to satisfy the fuel delivery demand.

12. A fuel pump arrangement according to claim 1, further comprising one or more one-way valves for connecting the pumping chamber of the or each pump unit to a common rail of the fuel injection system.

13. A method for delivering fuel to a common rail in a fuel injection system comprising a fuel pump arrangement according to claim 1, the method comprising:
calculating a fuel delivery demand; and
delivering fuel from the fuel pump arrangement to the common rail during the first pumping stroke and/or the second pumping stroke to satisfy the fuel delivery demand.

14. A method according to claim 13, comprising delivering fuel from the fuel pump arrangement to the common rail during only a part of the first pumping stroke and/or only a part of the second pumping stroke to satisfy the fuel delivery demand.

15. A method according to claim 13, comprising delivering fuel from the fuel pump arrangement to the common rail during only the first pumping stroke or only the second pumping stroke to satisfy the fuel delivery demand.
